(19) United States
(12) Patent Application Publication
(10) Pub. No.: US 2023/0239814 A1
(43) Pub. Date: Jul. 27, 2023

(54) ELECTRONIC DEVICE FOR CONTROLLING SWITCHING TIMING FOR TRANSMISSION AND RECEPTION IN COMMUNICATION SYSTEM AND OPERATING METHOD THEREOF

(71) Applicant: Samsung Electronics Co., Ltd., Suwon-si (KR)

(72) Inventors: Geonwoong JUNG, Suwon-si (KR); Seunghyun LEE, Suwon-si (KR); Juho LEE, Suwon-si (KR); Jungsoo JUNG, Suwon-si (KR)

(21) Appl. No.: 18/157,485

(22) Filed: Jan. 20, 2023

(30) Foreign Application Priority Data
Jan. 24, 2022 (KR) 10-2022-0009686

(51) Int. Cl. H04W 56/00

(52) U.S. Cl. CPC H04W 56/0005

(57) ABSTRACT

The disclosure relates to a fifth generation (5G) or sixth generation (6G) communication system for supporting a higher data transmission rate. An electronic device is provided. The electronic device includes a reconfigurable intelligent surface (RIS) including multiple reflection elements, and a communication node electrically connected to the RIS, wherein the communication node includes a transceiver and at least one processor configured to control the multiple reflection elements. The communication node is configured to receive a time estimation value (T_{ES}) associated with a propagation delay and a control signal from a base station of a first network, perform, based on the time estimation value and the control signal, early switching into an uplink reflection pattern at a second time point earlier than a preconfigured first time point, so as to reflect a signal, which is transmitted from a terminal.

### CROSS-REFERENCE TO RELATED APPLICATION(S)

This application is based on and claims priority under 35 U.S.C. § 119(a) of a Korean patent application number 10-2022-0009686, filed on Jan. 24, 2022, in the Korean Intellectual Property Office, the disclosure of which is incorporated by reference herein in its entirety.

### BACKGROUND

### 1. Field

The disclosure relates to a communication system. More particularly, the disclosure relates to an electronic device for controlling switching timing for transmission and reception and an operating method thereof.

### 2. Description of Related Art

Fifth generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (for example, 95 GHz to 3 terahertz (THz) bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input-multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for controlling a reflection element by considering a propagation delay between a base station and a terminal in order to transmit and receive signals more quickly.

Additional aspects will be set forth in part in the description which follows and, in part, will be apparent from the description, or may be learned by practice of the presented embodiments.

In accordance with an aspect of the disclosure, an electronic device is provided. The electronic device includes a reconfigurable intelligent surface (RIS) including multiple reflection elements, and a communication node electrically connected to the RIS, wherein the communication node includes a transceiver and at least one processor configured to control the multiple reflection elements. The communication node is configured to receive a time estimation value (T_{ES}) associated with a propagation delay and a control signal from a base station of a first network, and based on the time estimation value and the control signal, perform early switching into an uplink reflection pattern at a second time point earlier than a preconfigured first time point, so as to reflect a signal, which is transmitted from a terminal, according to the uplink reflection pattern in response to a timing at which the signal arrives at the RIS.

An electronic device according to the disclosure may transmit and receive signals more quickly by controlling a reflection element by considering a propagation delay between a base station and a terminal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a conceptual diagram illustrating a communication environment of a communication system according to an embodiment of the disclosure;

FIG. 2 is a conceptual diagram illustrating an interval in which an uplink signal and a downlink signal are transmitted in a communication system 1 according to an embodiment of the disclosure;

FIG. 3 is a conceptual diagram illustrating a time point at which uplink signals transmitted from multiple terminals are received by an RIS and a base station in a communication system according to an embodiment of the disclosure;

FIG. 4 is a conceptual diagram illustrating an interval in which an uplink signal and a downlink signal are transmitted in a communication system according to an embodiment of the disclosure;

FIG. 5 is a conceptual diagram illustrating a time point at which uplink signals are transmitted from multiple terminals respectively, a time point at which the uplink signal is incident to an RIS device, and a reflection pattern switching time of the RIS device in a communication system according to an embodiment of the disclosure;

FIG. 6 is a conceptual diagram illustrating an early switching operation of an RIS device in a communication system according to an embodiment of the disclosure;

FIG. 7 is a conceptual diagram illustrating a control signal received by an RIS device from a base station in a communication system according to an embodiment of the disclosure;

FIG. 8 is a conceptual diagram illustrating a control signal transmitted from a base station to an RIS device in a communication system according to an embodiment of the disclosure;

FIG. 9 is a conceptual diagram illustrating a control signal transmitted from a base station to an RIS device in a communication system according to an embodiment of the disclosure;

FIG. 10 is a conceptual diagram illustrating an early switching operation of an RIS device in a communication system according to an embodiment of the disclosure;

FIG. 11 is a conceptual diagram illustrating an early switching operation of an RIS device in a communication system according to an embodiment of the disclosure;

FIG. 12 is a block diagram illustrating a base station in a communication system according to an embodiment of the disclosure;

FIG. 13 is a block diagram illustrating an RIS device in a communication system according to an embodiment of the disclosure; and

FIG. 14 is a block diagram illustrating a terminal in a communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

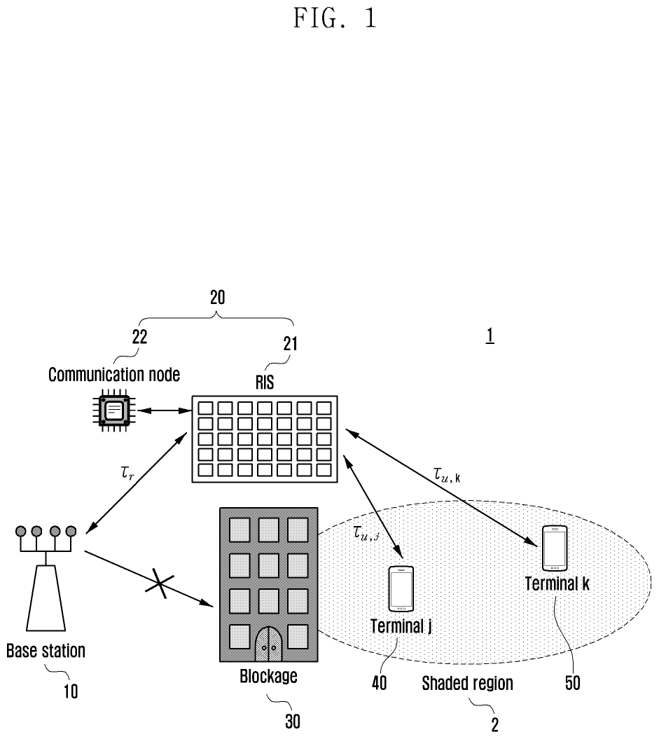

FIG. 1 is a conceptual diagram illustrating a communication environment of a communication system 1 according to an embodiment of the disclosure.

Referring to FIG. 1, a communication system 1 may include a base station 10, at least one reconfigurable intelligent surface (RIS) device 20, and multiple terminals 40 to 60. For example, the communication system 1 may be a fourth generation (4G) communication system or a 5G communication system.

An obstacle 30 may be disposed between the multiple terminals 40 to 60 and a base station 10. The multiple terminals 40 to 60 may be located in a shaded area 2 in which there is no signal received from the base station 10 due to the obstacle 30.

The RIS device 20 may be disposed between the multiple terminals 40 to 60 and the base station 10. The RIS device 20 may reflect a radio signal incident from one direction to another direction. For example, the RIS device 20 may reflect a radio signal, which is incident from a direction in which the base station 10 is located, to a direction in which the multiple terminals 40 to 60 are located. In addition, the RIS device 20 may reflect a radio signal, which is incident from a direction in which the multiple terminals 40 to 60 are located, to a direction where the base station 10 is located. For example, the RIS device 20 may reflect a signal transmitted from the base station 10 so as to enable the multiple terminals 40 to 60 to receive the signal. In addition, the RIS device 20 may reflect signals transmitted from the multiple terminals 40 to 60 so as to enable the base station 10 to receive the signals. For example, the RIS device 20 may reflect a signal transmitted from the base station 10 to the multiple terminals 40 to 60. For example, a signal transmitted from the base station 10 may be reflected by the RIS device 20 and transmitted to the multiple terminals 40 to 60. For example, signals transmitted from the multiple terminals 40 to 60 may be reflected by the RIS device 20 and transmitted to the base station 10.

The RIS device 20 may include an RIS 21 and a communication node 22. For example, the RIS 21 may include multiple reflection elements (Res). The communication node 22 may include an RIS controller and a transceiver capable of communicating with the base station 10. The communication node 22 may be electrically connected to the RIS 21. For example, the communication node 22 may be connected to the RIS 21 wirelessly or wired. The communication node 22 may be electrically connected to the base station 10. For example, the communication node 22 may be connected to the base station 10 wirelessly or wired.

The communication node 22 may receive a control signal from the base station 10. The communication node 22 may control the RIS 21 based on a control signal. For example, the communication node 22 may control the phase and amplitude of the RIS 21 based on the control signal. For example, the communication node 22 may control the phase and amplitude of each of the multiple Res based on the control signal. For example, a combination of phase and amplitude of each of multiple Res may be referred to as a reflection pattern. For example, the RIS 21 may have various reflection patterns according to the combination of phase and amplitude of each of the multiple Res.

The communication node 22 may be time synchronized with the base station 10. For example, the communication node 22 may be time-synchronized with the base station by receiving a time synchronization signal transmitted by the base station 10. For example, the time synchronization signal may include a primary synchronization signal (PSS) and a secondary synchronization signal (SSS).

The base station 10 may transmit a control signal to the communication node 22 through a physical layer signal or a higher layer signal. For example, the physical layer signal may be L1 signaling. For example, the higher layer signal may be RRC signaling. For example, the control signal may include information indicating phase and amplitude of each of multiple Res. For example, information indicating phase and amplitude of each of multiple Res may be referred to as reflection pattern information.

A propagation delay may occur between the base station 10 and the RIS device 20. For example, a signal transmitted/received, incident, and reflected between the base station 10 and the RIS device 20 may be delayed by a time equal to the propagation delay time τᵣ.

A propagation delay may occur between the RIS device 20 and the multiple terminals 40 and 50. For example, a signal incident and reflected between the RIS device 20 and the terminal k 40 may be delayed by a time equal to the propagation delay time τ_{u,k}.

For example, a signal incident and reflected between the RIS device 20 and The terminal j 50 may be delayed by a time equal to the propagation delay time τ_{u,j}.

The communication system 1 may include multiple networks. For example, the communication system 1 may include a first network (not shown) including the base station 10. For example, the communication system 1 may include a first network (not shown) including the base station 10 and a second network (not shown) including a connectable communication node (not shown).

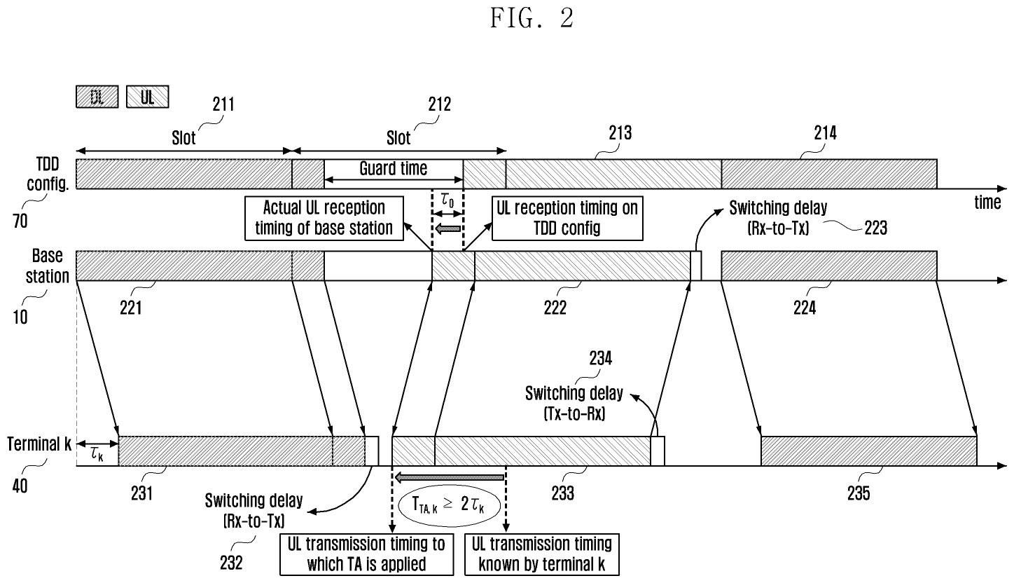

FIG. 2 is a conceptual diagram illustrating an interval in which an uplink signal and a downlink signal are transmitted in a communication system 1 according to an embodiment of the disclosure.

Referring to FIG. 2, the communication system 1 may use time-division duplex (TDD). For example, TDD may be TDD of a 4G communication system or dynamic TDD of a 5G communication system. For example, a base station 10, an RIS device 20, and multiple terminals 40 and 50 may transmit and receive signals based on TDD configuration information 70. The TDD configuration information 70 may indicate, in a time resource, an interval in which an uplink signal is transmitted, an interval in which a downlink signal is transmitted, and a flexible interval (flexible slot) capable of variably operating the uplink signal and the downlink signal. The TDD configuration information may indicate a guard time interval between the interval in which the uplink signal is transmitted and the interval in which the downlink signal is transmitted.

For example, the TDD configuration information 70 may indicate a first downlink interval 211 in which a first downlink signal is transmitted, a first uplink interval 212 in which a first uplink signal is transmitted, a guard time interval 213 between the first downlink interval 211 and the first uplink interval 212, and a second downlink interval 214 in which a second downlink signal is transmitted.

The base station 10 may transmit the first downlink signal to a terminal k 40 in a first downlink interval 221 based on the TDD configuration information 70. The first downlink interval 221 may be the same as the first downlink interval 211 indicated by the TDD configuration information 70.

The terminal k 40 may receive the first downlink signal from the base station 10 in a first downlink interval 231 based on the TDD configuration information 70. In this case, the first downlink interval 231 of the terminal k 40 may be different from the first downlink interval 221 of the base station 10. For example, the first downlink interval 231 of the terminal k 40 may correspond to an interval delayed by a time equal to the propagation delay time τₖ than the first downlink interval 221 of the base station 10. For example, the terminal k 40 may receive the first downlink signal, which is transmitted by the base station 10 in the first downlink interval 221, in the first downlink interval 231 delayed by a time equal to the propagation delay time τₖ. In the terminal k 40, a hardware switching delay 232 may occur when switching from a reception mode to a transmission mode.

The terminal k 40 may transmit a first uplink signal in a first uplink interval 233 based on the TDD configuration information 70 and a timing advance (TA) value T_{TA,k}. For example, the timing advance value T_{TA,k} may be determined based on round-trip propagation delay time 2τₖ and timing offset τ₀. For example, the base station 10 may estimate the round-trip propagation delay time 2τₖ, based on a preamble signal transmitted by the terminal k 40, in a random access procedure of the terminal k 40. For example, τ₀ may be determined including a hardware switching delay occurring during switching from a reception mode to a transmission mode of the base station 10 and a hardware switching delay occurring during switching from a transmission mode to a reception mode of the terminal k 40. For example, τ₀ may differ according to a frequency band in which the base station 10 or the terminal k 40 operates. The base station 10 may determine a timing advance value T_{TA,k} for the terminal k 40 based on the estimated round-trip propagation delay time 2τₖ and the timing offset τ₀. For example, the timing advance value T_{TA,k} may be equal to or greater than the estimated round-trip propagation delay value 2_{τk} (that is, T_{TA,k}≥2_{τk}). The base station 10 may transmit a random access response (RAR) message including the determined timing advance value T_{TA,k} to the terminal k 40. For example, an uplink transmission start timing to which the timing advance value T_{TA,k} is applied may correspond to a timing preceding as much as the timing advance value T_{TA,k} than the start timing of the first uplink interval 213 indicated by the TDD configuration information 70.

The base station 10 may receive a first uplink signal from the terminal k 40 in the first uplink interval 222 based on the TDD configuration information 70. The start timing of the first uplink interval 222 in which the base station 10 receives the first uplink signal may correspond to a timing preceding as much as the timing τ₀ than the start timing of the first uplink interval 213 indicated by the TDD configuration information 70. The base station 10 may transmit a second downlink signal to the terminal k 40 in a second downlink interval 224 based on the TDD configuration information 70. The second downlink interval 224 may be the same as the second downlink interval 214 indicated by the TDD configuration information 70.

The terminal k 40 may receive the second downlink signal from the base station 10 in a second downlink interval 235 based on the TDD configuration information 70. In this case, the second downlink interval 235 of the terminal k 40 may be different from the second downlink interval 224 of the base station 10. For example, the second downlink interval 235 of the terminal k 40 may correspond to an interval delayed by a time equal to the random propagation delay time than the second downlink interval 224 of the base station 10. For example, the random propagation delay time may be τₖ. For example, the terminal k 40 may receive the second downlink signal, which is transmitted by the base station 10 in the second downlink interval 224, in the second downlink interval 235 delayed by a time equal to the propagation delay time τₖ.

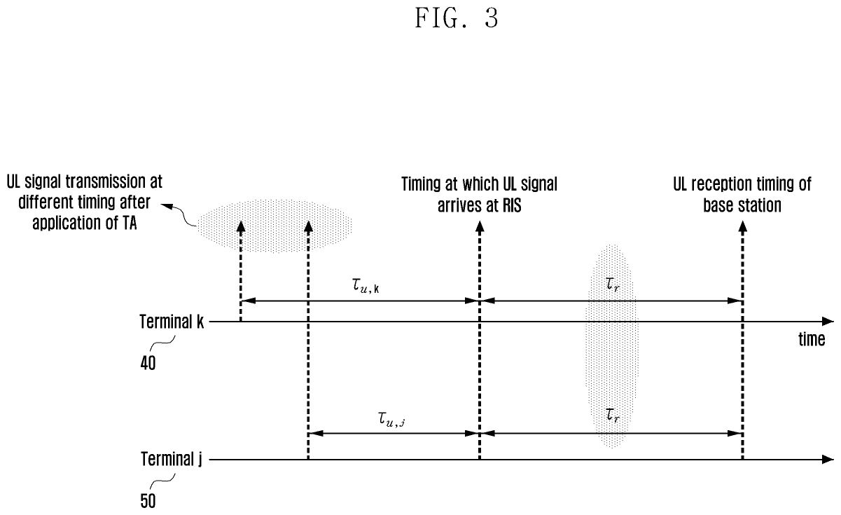

FIG. 3 is a conceptual diagram illustrating a time point at which uplink signals transmitted from multiple terminals 40 and 50 arrive at an RIS device 20 and are received by a base station 10 in a communication system 1 according to an embodiment of the disclosure.

Referring to FIG. 3, the terminal k 40 may transmit an uplink signal to the base station 10 based on a TA value. The uplink signal transmitted by the terminal k 40 may arrive at the RIS device 20 at a time when a propagation delay time τ_{u,k} has elapsed from the transmission time.

The terminal j 50 may transmit an uplink signal to base station 10 based on the TA value. The TA value of the terminal j 50 may be different from the TA value of the terminal k 40. The uplink signal transmitted by the terminal j 50 may arrive at the RIS device 20 at a time when a propagation delay time τ_{u,j} has elapsed from the transmission time. For example, uplink signals transmitted by the multiple terminals 40 and 50 may arrive at the RIS device 20 at the same time.

The RIS device 20 may reflect the uplink signal transmitted by the terminal k 40 to the base station 10. For example, the RIS device 20 may reflect the uplink signal transmitted by the terminal k 40 to the base station 10 by using a specific uplink reflection pattern. The base station 10 may receive the uplink signal at a time point at which a propagation delay time τᵣ has elapsed from a time point at which the RIS device 20 has reflected the uplink signal.

The RIS device 20 may reflect the uplink signal transmitted by the terminal j 50 to the base station 10. For example, the RIS device 20 may reflect the uplink signal transmitted by the terminal j 50 to the base station 10 by using a specific uplink reflection pattern. The base station 10 may receive the uplink signal at a time point at which the propagation delay time τᵣ has elapsed from a time point at which the RIS device 20 has reflected the uplink signal.

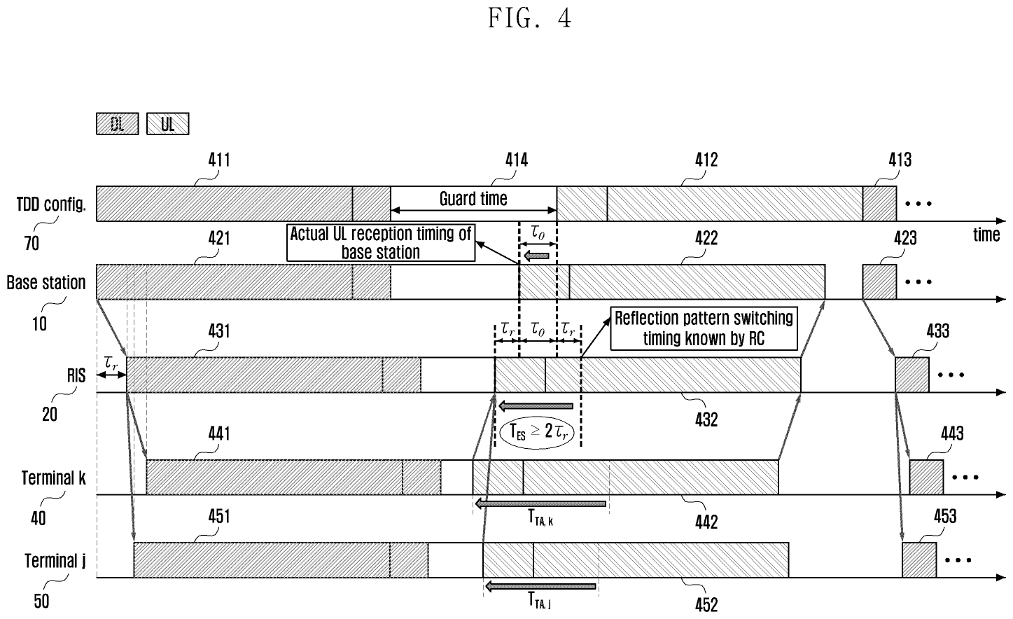

FIG. 4 is a conceptual diagram illustrating an interval in which an uplink signal and a downlink signal are transmitted in a communication system 1 according to an embodiment of the disclosure.

Referring to FIG. 4, the communication system 1 may use time-division duplex (TDD). For example, a base station 10, an RIS device 20, and multiple terminals 40 and 50 may transmit and receive signals based on TDD configuration information 70. The TDD configuration information 70 may indicate, in a time resource, an interval in which an uplink signal is transmitted, an interval in which a downlink signal is transmitted, and a flexible interval (flexible slot) capable of variably operating the uplink signal and the downlink signal. The TDD configuration information may indicate a guard time interval between the interval in which the uplink signal is transmitted and the interval in which the downlink signal is transmitted.

For example, the TDD configuration information 70 may indicate a first downlink interval 411 in which a first downlink signal is transmitted, a first uplink interval 412 in which a first uplink signal is transmitted, a second downlink interval 413 in which a second downlink signal is transmitted, and a guard time interval 414 between the first downlink interval 411 and the first uplink interval 412.

The base station 10 may transmit the first downlink signal to the multiple terminals 40 and 50 in a first downlink interval 421 based on the TDD configuration information 70. The first downlink interval 421 of the base station 10 may be the same as the first downlink interval 411 indicated by the TDD configuration information 70.

The first downlink signal transmitted by the base station 10 based on the TDD configuration information 70 may arrive at the RIS device 20 in a first downlink interval 431. In this case, the first downlink interval 431 of the RIS device 20 may be different from the first downlink interval 421 of the base station 10. For example, the first downlink interval 431 of the RIS device 20 may correspond to an interval delayed by a time equal to the propagation delay time τᵣ than the first downlink interval 421 of the base station 10. For example, the first downlink signal, which is transmitted by the base station 10 in the first downlink interval 421, may arrive at the RIS device 20 in the first downlink interval 431 delayed by a time equal to the propagation delay time τᵣ.

In the terminal k 40, a hardware switching delay 232 may occur during switching from a reception mode to a transmission mode.

The terminal k 40 may receive the first downlink signal reflected from the RIS device 20 in a first downlink interval 441 based on the TDD configuration information 70. In this case, the first downlink interval 441 of the terminal k 40 may be different from the first downlink interval 431 of the RIS device 20. For example, the first downlink interval 441 of the terminal k 40 may correspond to an interval delayed by a time equal to the propagation delay time τₖ than the first downlink interval 431 of the RIS device 20. For example, the terminal k 40 may receive the first downlink signal, which is reflected by the RIS device 20 in the first downlink interval 431, in the first downlink interval 441 delayed by a time equal to the propagation delay time τₖ.

The terminal j 50 may receive the first downlink signal, which is reflected from the RIS device 20 in the first downlink interval 451, based on the TDD configuration information 70 in the first downlink interval 451 delayed by a time equal to the propagation delay time τⱼ.

The terminal j 50 may transmit a first uplink signal to the base station 10 in a first uplink interval 452 based on the TDD configuration information 70 and the TA value. For example, the timing advance value T_{TA,j} may be determined based on the round-trip propagation delay time 2τⱼ and the timing offset τ₀. For example, the base station 10 may estimate the round-trip propagation delay time 2τⱼ, based on a preamble signal transmitted by the terminal j 50, in a random access procedure of the terminal j 50. For example, τ₀ may be determined including a hardware switching delay occurring during switching from a reception mode to a transmission mode of the base station 10 and a hardware switching delay occurring during switching from a transmission mode to a reception mode of the terminal j 50. For example, τ₀ may differ according to a frequency band in which the base station 10 or the terminal j 50 operates. The base station 10 may determine a timing advance value T_{TA,j} for the terminal j 50 based on the estimated round-trip propagation delay time 2τⱼ and the timing offset τ₀. For example, the timing advance value T_{TA,j} may be equal to or greater than the estimated round-trip propagation delay time 2τⱼ (that is, T_{TA,j}≥2τⱼ). The base station 10 may transmit a random access response (RAR) message including the determined timing advance value T_{TA,j} to the terminal j 50. For example, the uplink transmission start timing to which the timing advance value T_{TA,j} is applied may correspond to a timing preceding as much as the timing advance value T_{TA,j} than the start timing of the first uplink interval 412 indicated by the TDD configuration information 70.

The terminal k 40 may transmit a first uplink signal to the base station 10 in a first uplink interval 442 based on the TDD configuration information 70 and the TA value. For example, the timing advance value T_{TA,k} may be determined based on the round-trip propagation delay time 2τₖ and the timing offset τ₀. For example, the base station 10 may estimate the round-trip propagation delay time 2τₖ, based on a preamble signal transmitted by the terminal k 40, in a random access procedure of the terminal k 40. The base station 10 may determine a timing advance value T_{TA,k} for the terminal k 40 based on the estimated round-trip propagation delay time 2τₖ and the timing offset τ₀. For example, the timing advance value T_{TA,k} may be equal to or greater than the estimated round-trip propagation delay time 2τₖ (that is, T_{TA,k}≥2τₖ).

The RIS device 20 may receive a control signal including reflection pattern information and early switching information from the base station 10. For example, the control signal may be transmitted through physical layer signaling (L1 signaling) or higher layer signaling (RRC signaling). For example, the reflection pattern information may indicate a time and a reflection pattern to be configured. For example, the reflection pattern may be configured for each symbol unit. For example, the reflection pattern information may be configured to reflect a downlink signal and an uplink signal. For example, early switching information may indicate a timing at which the reflection pattern should be configured faster, by a value of T_{ES}, than a timing indicated by the reflection pattern information. For example, the early switching information may indicate a timing at which the reflection pattern should be configured faster than the value of T_{ES} than a timing indicated by the reflection pattern information. For example, T_{ES} may be equal to or greater than 2τᵣ (that is, T_{ES}≥2τᵣ). For example, the T_{ES} may be transmitted to the RIS device 20 through a separate signal from the base station 10 without being included in the control signal. For example, T_{ES} may be included in the control signal.

The RIS device 20 may reflect the first uplink signal, which is incident from the terminal k 40, to the base station 10 in a first uplink interval 432 based on the TDD configuration information 70. The start timing of the first uplink interval 432 at which the RIS device 20 receives the incident first uplink signal may correspond to a timing preceding as much as T_{ES} than a timing indicated by the reflection pattern information. The RIS device 20 may perform early switching, into an uplink reflection pattern, of an uplink signal incident to the RIS device 20, at a timing preceding as much as T_{ES} than the start timing of the first uplink interval 432 indicated by the reflection pattern information. Alternatively, the RIS device 20 may perform early switching, into an uplink reflection pattern, of the uplink signal incident to the RIS device 20, at a timing preceding more than a value of T_{ES} than the start timing of the first uplink interval 432 indicated by the reflection pattern information.

The RIS device 20 may receive a control signal including early switching information from the base station 10. For example, the early switching information may indicate a timing of changing the reflection pattern of the RIS device 20 into an uplink reflection pattern for uplink signal reflection or a downlink reflection pattern for downlink signal reflection. For example, T_{ES} may be equal to or greater than 2τᵣ (that is, T_{ES}≥2τᵣ).

The RIS device 20 may determine a timing of changing a reflection pattern based on the T_{ES}, the reflection pattern information, and the early switching information. For example, the RIS device 20 may perform early switching from the downlink reflection pattern to the uplink reflection pattern at a timing preceding as much as T_{ES} than a timing of changing the reflection pattern indicated by the reflection pattern information. For example, the RIS device 20 may perform early switching from the downlink reflection pattern to the uplink reflection pattern at a timing preceding more than a value of T_{ES} than a timing of changing the reflection pattern indicated by the reflection pattern information. For example, the timing at which the early switching should be performed may be included in the early switching information.

The base station 10 may receive the first uplink signal from the RIS device 20 in the first uplink interval 422 based on the TDD configuration information 70. The start timing of the first uplink interval 422 in which the base station 10 receives the first uplink signal may correspond to a timing preceding as much as time τ₀ than the start timing of the first uplink interval 412 indicated by the TDD configuration information 70.

The base station 10 may transmit the second downlink signal to the multiple terminals 40 and 50 in the second downlink interval 413 based on the TDD configuration information 70. The RIS device 20 may reflect the second downlink signal, which is transmitted from the base station 10 based on the TDD configuration information 70, in a second downlink interval 433.

The RIS device 20 may reflect the second downlink signal to the terminal k 40 in the second downlink interval 433 based on the TDD configuration information 70. The terminal k 40 may receive the second downlink signal, which is reflected from the RIS device 20, in the second downlink interval 443 based on the TDD configuration information 70.

The RIS device 20 may reflect the second downlink signal to the terminal j 50 in the second downlink interval 433 based on the TDD configuration information 70. The terminal j 50 may receive the second downlink signal which is reflected from the RIS device 20, in the second downlink interval 453 based on the TDD configuration information 70.

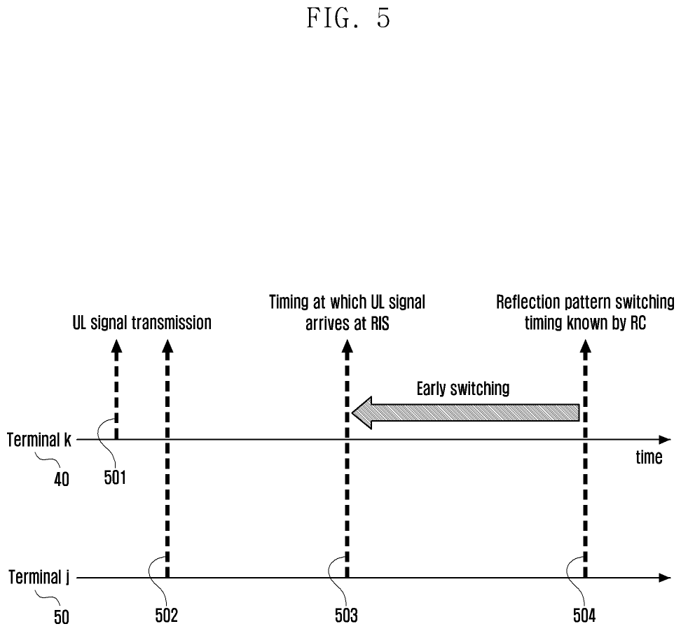

FIG. 5 is a conceptual diagram illustrating a time point at which uplink signals are transmitted from multiple terminals 40 and 50 respectively, a time point at which the uplink signal is incident to an RIS device 20, and a reflection pattern switching time of the RIS device 20 in a communication system 1 according to an embodiment of the disclosure.

Referring to FIG. 5, the terminal k 40 may transmit an uplink signal to the base station 10 at a first time point 501 based on the TA value. The uplink signal may be incident to the RIS device 20 at a third time point 503 corresponding to a time when a propagation delay time τ_{u,k} has elapsed from a second time point 502 at which the terminal k 40 transmits the uplink signal. The RIS device 20 may reflect the uplink signal transmitted by the terminal k 40 and having been incident at the third time point 503 to the base station 10 by using a specific uplink reflection pattern. The uplink signal may be incident to the RIS device 20 at the third time point 503 corresponding to a time point at which a propagation delay time τ_{u,j} has elapsed from the second time point 502 at which the terminal j 50 transmits the uplink signal. The RIS device 20 may reflect the uplink signal transmitted by the terminal j 50 and having been incident at the third time point 503 to the base station 10 by using a specific uplink reflection pattern. The uplink signals transmitted from the multiple terminals 40 and 50 respectively at the third time point 503 may be incident to the RIS device 20 at the third time point 503, and the incident uplink signals may be reflected to the base station 10 by using a specific reflection pattern.

The RIS device 20 may reflect signals to the base station 10 according to an uplink reflection pattern at a timing (indicated by reference numeral 503) which is faster, by a value of T_{ES}, than a time point 504 for switching into the uplink reflection pattern according to a timing at which the uplink signals arrive at the RIS device 20, based on the T_{ES}, the reflection pattern information, and the early switching information. The RIS device 20 may reflect the signals to the base station 10 according to an uplink reflection pattern at a timing which is faster more than a value of T_{ES} than a time point 504 for switching into the uplink reflection pattern according to a timing at which the uplink signals arrive at the RIS device 20, based on the T_{ES}, the reflection pattern information, and the early switching information.

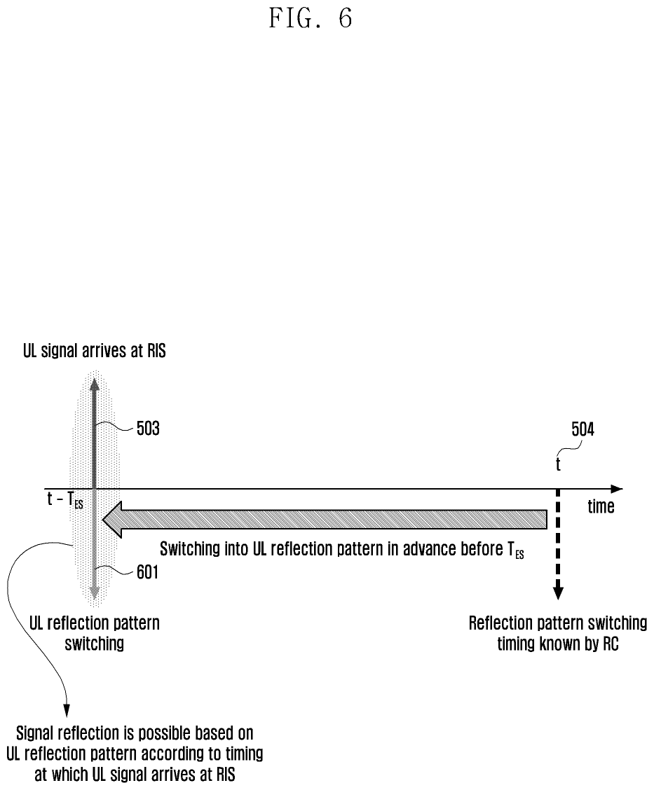

FIG. 6 is a conceptual diagram illustrating an early switching operation of an RIS device 20 in a communication system 1 according to an embodiment of the disclosure.

Referring to FIG. 6, the RIS device 20 may determine a time of switching a reflection pattern based on the T_{ES}, reflection pattern, and early switching information. For example, a time t 504 for switching the reflection pattern indicated by the reflection pattern information may be referred to as a first switching time. A reflection pattern switching time 601 determined based on the T_{ES} and the first switching time t 504 may be referred to as a second switching time. For example, the second switching time 601 may be a time corresponding to (t−T_{ES}). For example, the second switching time may correspond to a time preceding more than (t−T_{ES}). The second switching time 601 may be the same as the third time point 503 at which an uplink signal is received from each of the multiple terminals 40 and 50. The RIS device 20 may be configured not to perform switching into the uplink reflection pattern at the first switching time t 504, but to perform early switching into the uplink reflection pattern in advance at the second switching time 601 determined based on the T_{ES} and early switching information.

For example, T_{ES}=2τᵣ+τ₀. 2τᵣ may be a round trip time (RTT) at which a signal is incident and reflected between the base station 10 and the RIS device 20. T0 may be a timing offset. For example, τ₀ may be different for each frequency band.

The RIS device 20 may receive the T_{ES} from the base station 10 through a random access (RA) procedure with the base station 10 in an in-band.

The RIS device 20 may acquire the T_{ES} through a random access procedure with the base station 10 in an out-band. For example, through the random access procedure with the base station 10 of the RIS device 20 in the out-band, the RIS device 20 may be configured to receive, from the base station 10, a time estimation value (T_{ES}) in the out-band including a round-trip propagation delay time (2τᵣ) between the base station 10 and the RIS device 20 and a timing offset (τ′₀) configured in the out-band and receive all of multiple timing offsets (τ₀, τ′₀) configured in the in- and out-band, and thus the RIS device 20 may be configured to calculate a time estimation value (T_{ES}) required for early switching based on the time estimation value (T_{ES}) in the out-band and the timing offsets (τ₀, τ′₀).

The RIS device 20 may be connected to the base station 10 through a communication node of the second network rather than the first network. For example, when the RIS device 20 is connected to the base station 10 through the communication node of the second network, the base station 10 or the RIS device 20 may estimate the RTT value using an RTT estimation technique, and the base station 10 may transmit, to the RIS device 20, the timing offset τ₀ required for early switching, in addition to the RTT, so as to enable the RIS device 20 to estimate the T_{ES}. For example, the RTT estimation technique may be a fine timing measurement (FTM) technique.

In case that the RIS device 20 is connected to the base station 10 through a communication node of the second network rather than the first network, the RIS device 20 may estimate or acquire T_{ES} based on a round trip time (RTT) estimation method.

For example, the round-trip propagation delay time may be estimated by the base station 10 or the RIS device 20 using the RTT estimation method. For example, the RTT estimation method may be a fine timing measurement (FTM).

For example, when the RIS device 20 may be configured to estimate the round-trip propagation delay time, the RIS device 20 may be configured to receive a timing offset τ0 configured within a bandwidth required for early switching in addition to the round-trip propagation delay time from the base station 10, and the RIS device 20 may be configured to estimate a time estimation value T_{ES} required for early switching based on the round-trip propagation delay time and the timing offset.

For example, when the base station 10 estimates the round-trip propagation delay time, the base station 10 may be configured to calculate a time estimation value T_{ES} required for early switching based on the round-trip propagation delay time and a timing offset configured within a bandwidth, and transmit the T_{ES} to the RIS device 20. For example, when the base station 10 estimates the round-trip propagation delay time, the base station 10 may be configured to transmit the round-trip propagation delay time and the timing offset configured in the in-band to the RIS device 20, and the RIS device 20 may be configured to estimate a time estimation value T_{ES} required for early switching based on the round-trip propagation delay time and the timing offset.

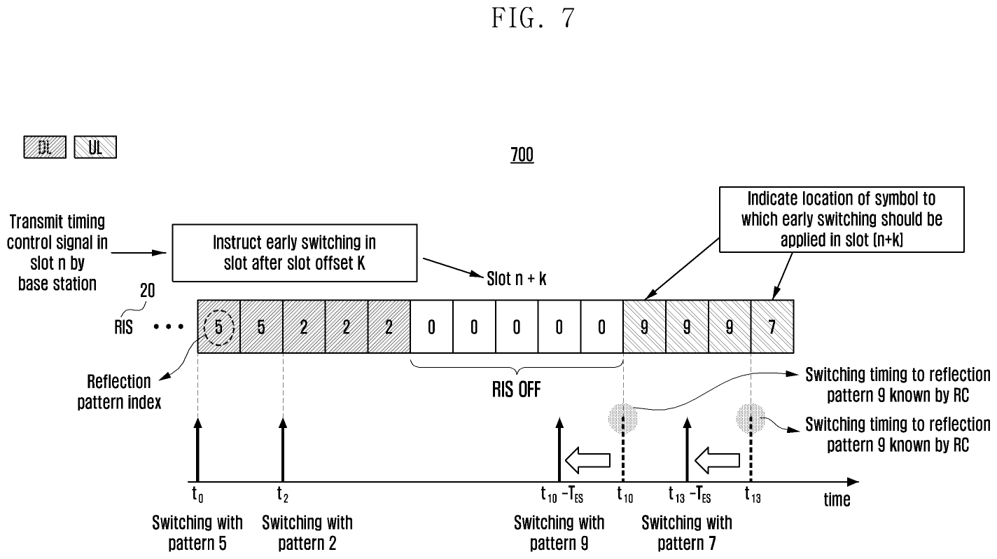

FIG. 7 is a conceptual diagram illustrating a control signal received by an RIS device 20 from a base station 10 in a communication system 1 according to an embodiment of the disclosure.

Referring to FIG. 7, a control signal 700 may include reflection pattern information indicating a reflection pattern to be applied at each timing. The reflection pattern information may include timing information by which each reflection pattern is switched. For example, each reflection pattern may be switched at each starting timing of each symbol. The control signal 700 may include information indicating a time when the reflection pattern information is applied. For example, the control signal 700 may indicate to apply the reflection pattern information in a slot after slot offset K from a time point at which the RIS device 20 has received the control signal 700. For example, the control signal 700 may indicate a slot, to which the reflection pattern information is applied, using a system frame number (SFN), a subframe number, and a slot number.

For example, the reflection pattern information may indicate a reflection pattern index applied to each symbol. For example, the reflection pattern information may indicate to apply reflection pattern index 5 from time t₀ to time t₁ corresponding to symbol 0 to symbol 1. The reflection pattern information may indicate to apply reflection pattern index 2 from time t₂ to time t₄ corresponding to symbol 2 to symbol 4. For example, the reflection pattern information may indicate to apply reflection pattern index 0 from time t₅ to time t₉ corresponding to symbol 5 to symbol 9. For example, reflection pattern index 0 may indicate RIS OFF indicating turning off RIS power. For example, the reflection pattern information may indicate to apply reflection pattern index 9 from time t₁₀ to time t₁₂ corresponding to symbol 10 to symbol 12. For example, the reflection pattern information may indicate to apply reflection pattern index 7 at time t₁₃ corresponding to symbol 13.

For example, the RIS device 20 may apply reflection pattern index 5 from time t₀ to time t₁ corresponding to symbol 0 to symbol 1 based on the reflection pattern information. The RIS device 20 may switch a reflection pattern according to reflection pattern index 2 at time t₂ corresponding to symbol 2 based on the reflection pattern information. The RIS device 20 may apply reflection pattern index 2 from time t₂ to time t₄ corresponding to symbol 2 to symbol 4 based on the reflection pattern information. The RIS device 20 may switch a reflection pattern according to reflection pattern index 0 at time t₅ corresponding to symbol 5 based on the reflection pattern information.

The control signal 700 may include early switching information indicating a timing at which early switching is applied. The early switching information may indicate the locations of a slot and a symbol to which early switching is applied. For example, the control signal 700 may indicate to apply the early switching information in a slot after the slot offset K from a time point at which the RIS device 20 has received the control signal 700. For example, the control signal 700 may indicate a slot to which early switching information is applied by using a system frame number (SFN), a subframe number, and a slot number. The control signal 700 may indicate the location of the slot to which the early switching information is applied, by using the same information as that used to indicate the location of the slot to which the reflection pattern information is applied. For example, when the control signal 700 indicates that reflection pattern information is applied in a slot after slot offset K, the location of a slot to which early switching should be applied may also be indicated as a slot after slot offset K. For example, the control signal 700 may indicate the reflection pattern information and the early switching information together using the SFN, subframe number, and slot number. The control signal 700 may indicate a timing at which early switching should be performed within a slot to which early switching is applied, according to a symbol position. For example, the control signal 700 may instruct early switching at a timing at which a specific symbol belonging to a slot after the slot offset K starts.

The RIS device 20 may perform an early switching operation based on the T_{ES}, the reflection pattern information, and the early switching information. For example, the RIS device 20 may apply reflection pattern index 9 at a timing corresponding to time (t₁₀−T_{ES}) based on the T_{ES}, the reflection pattern information, and the early switching information. The RIS device 20 may apply reflection pattern index 7 at a timing corresponding to time (t₁₃−T_{ES}) based on the T_{ES}, the reflection pattern information, and the early switching information.

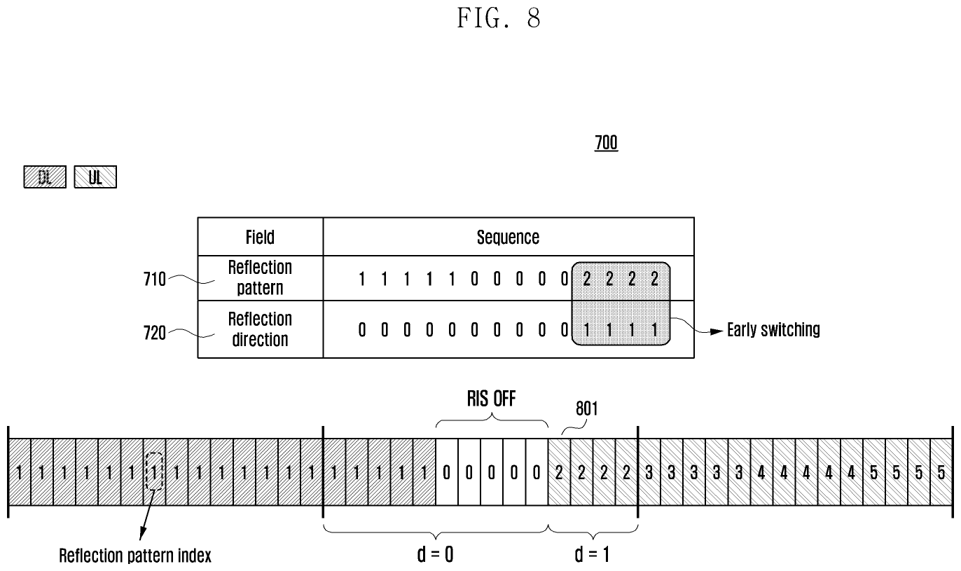

FIG. 8 is a conceptual diagram illustrating a control signal transmitted from a base station 10 to an RIS device 20 in a communication system 1 according to an embodiment of the disclosure.

Referring to FIG. 8, the control signal 700 may include reflection pattern information 710 and early switching information 720. The early switching information 720 may include a reflection direction indicator d. For example, the reflection direction indicator d may indicate a reflection operation of a specific reflection pattern.

For example, when the reflection direction indicator is 0 (d=0), a reflection pattern corresponding to reflection direction indicator 0 may indicate whether to reflect the downlink signal or not. Reflection direction indicator 0 may indicate not to apply early switching. When the reflection direction indicator is 1 (d=1), a reflection pattern corresponding to reflection direction indicator 1 may indicate to reflect the uplink signal. At the time of applying the uplink reflection pattern corresponding to reflection direction indicator 1, an instruction can be provided to apply early switching.

For example, a reflection direction indicator corresponding to symbol 0 to symbol 9 of slot 1 801 may correspond to 0. For example, the RIS device 20 may be configured to reflect a downlink signal according to a reflection pattern corresponding to reflection pattern index 1 in symbol 0 to symbol 4 of slot 1 801 based on the reflection pattern information 710 and the early switching information 720. The RIS device 20 may be configured not to perform a reflection operation on symbols 6 to 9 of slot 1 801 based on the reflection pattern information 710 and the early switching information 720 (RIS off).

The RIS device 20 may reflect the uplink signal according to a reflection pattern corresponding to reflection pattern index 2 in symbol 10 to symbol 13 of slot 1 801 based on the reflection pattern information 710 and the early switching information 720. The RIS device 20 may apply early switching in symbol 10 to symbol 13 of slot 1 801 based on the reflection pattern information 710 and the early switching information 720.

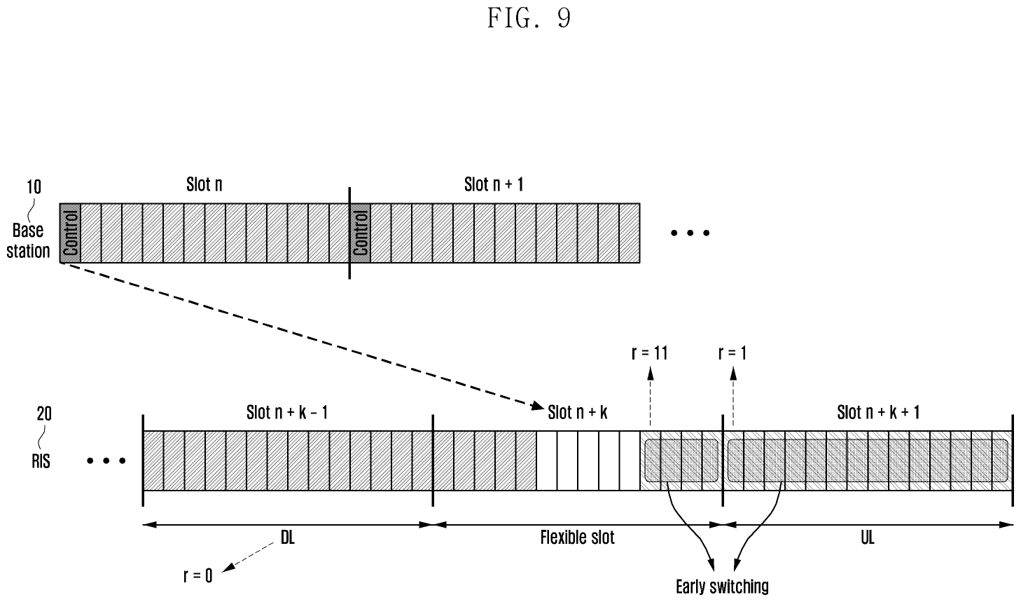

FIG. 9 is a conceptual diagram illustrating a control signal transmitted from a base station 10 to an RIS device 20 in a communication system 1 according to an embodiment of the disclosure.

Referring to FIG. 9, a control signal 700 including early switching information 720 may be transmitted from the base station 10 to the RIS device 20 through each slot. For example, the control signal 700 may be transmitted from the base station 10 to the RIS device 20 through symbol 0 of each slot.

The early switching information 720 may include a start symbol indicator r indicating the location of a symbol in which early switching starts. For example, when the start symbol indicator has a value of 0 (r=0), it may indicate that early switching is not applied in a slot to which the control signal 700 including the early switching information 720 is applied. If the start symbol indicator has a value greater than 0 (r>0), it may indicate that early switching is applied from the (r−1)th symbol of a slot to which the control signal 700 including the early switching information 720 is applied. For example, early switching may be applied from the (r−1)th symbol of the slot to which the control signal 700 is applied to the last symbol of the slot. Here, r may be an integer of 1≤r≤14.

For example, the base station 10 may generate early switching information 720 including a start symbol indicator having a value of 11 (r=11). The base station 10 may transmit early switching information 720 including the start symbol indicator (r=11) to the RIS device 20 through the control signal 700 in slot n. The RIS device 20 may apply the early switching information 720 including the start symbol indicator (r=11) received from the base station 10 in slot n+K. The RIS device 20 may perform an early switching operation in symbol 10 to symbol 13 of slot n+K based on the start symbol indicator (r=11).

The base station 10 may generate early switching information 720 including a start symbol indicator (r=1). The base station 10 may transmit early switching information 720 including the start symbol indicator (r=1) to the RIS device 20 in slot n+1. The RIS device 20 may apply the early switching information 720 including the start symbol indicator (r=1) received from the base station 10 in slot n+K+1. The RIS device 20 may perform an early switching operation in symbol 0 to symbol 13 of slot n+K+1 based on the start symbol indicator (r=1).

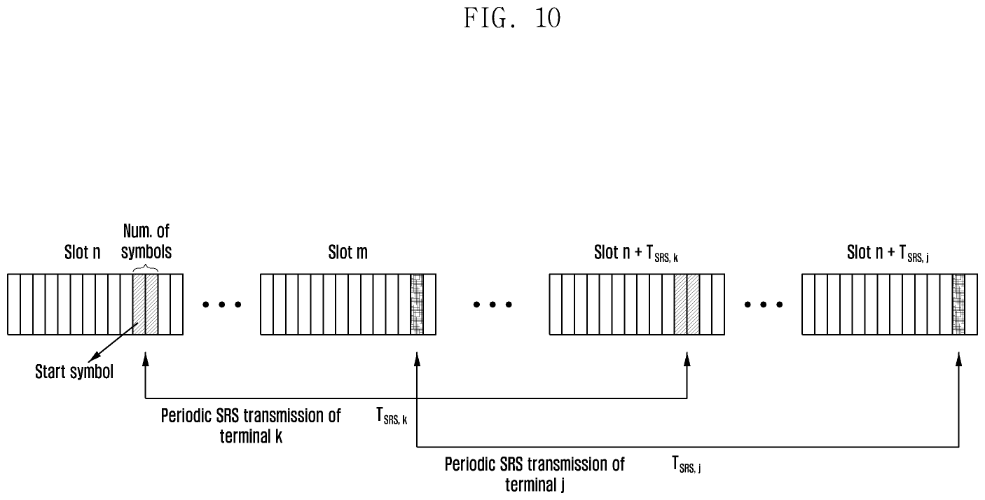

FIG. 10 is a conceptual diagram illustrating an early switching operation of the RIS device 20 in a communication system 1 according to an embodiment of the disclosure.

Referring to FIG. 10, a terminal k 40 may transmit a sounding reference signal (SRS) to a base station 10 through specific symbol(s) of each slot in a period of T_{SRS,k}. The RIS device 20 may reflect the periodic SRS, which is transmitted from the terminal k 40 in a period of T_{SRS,k}, in specific symbol(s) of each slot.

A terminal j 50 may transmit the SRS to the RIS device 20 through specific symbol(s) of each slot in a period of slot T_{SRS,j}. The RIS device 20 may reflect the periodic SRS, which is transmitted from the terminal j 50 in a period of T_{SRS,j}, in specific symbol(s) of each slot.

A base station 10 may generate a periodic SRS configuration parameter indicating an SRS transmission period of the multiple terminals 40 and 50 in the time domain. The base station 10 may transmit a control signal 700 including the periodic SRS configuration parameter to the RIS device 20. The RIS device 20 may receive a control signal 700 including the periodic SRS configuration parameter from the base station 10.

For example, the periodic SRS configuration parameter may be time domain parameters related to periodic SRS transmission. For example, the periodic SRS configuration parameter may include at least one of a slot period, a slot offset, a start symbol, and a number of symbols for the periodic SRS. Based on the periodic SRS configuration parameter, the RIS device 20 may periodically perform an early switching operation in each slot without having to repeatedly receive the control signal 700 whenever the SRS is periodically transmitted.

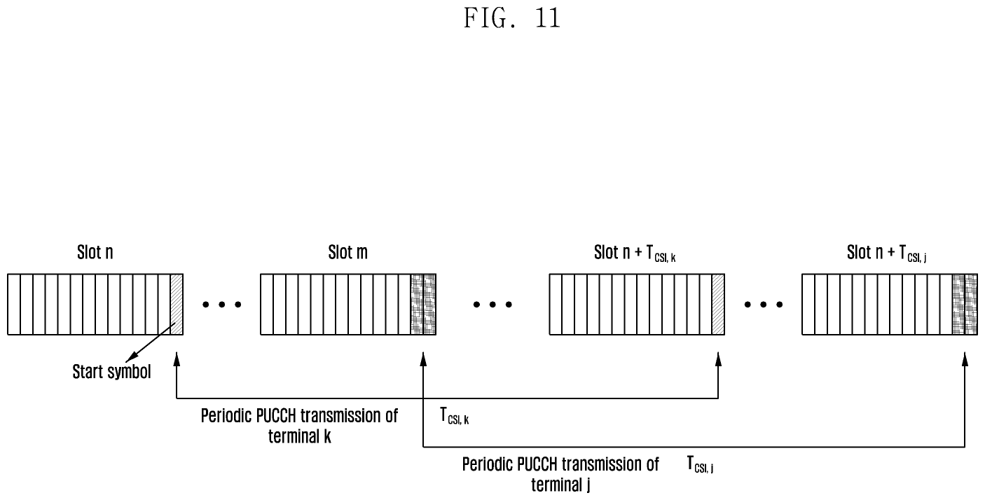

FIG. 11 is a conceptual diagram illustrating an early switching operation of an RIS device 20 in a communication system 1 according to an embodiment of the disclosure.

Referring to FIG. 11, a terminal k 40 may transmit a physical uplink control channel (PUCCH) to the RIS device 20 through specific symbol(s) of each slot in a period of T_{CSI,k}. The RIS device 20 may reflect the periodic PUCCH, which is transmitted from the terminal k 40 in a period of T_{CSI,k}, through specific symbol(s) of each slot.

A terminal j 50 may transmit the PUCCH to the RIS device 20 through specific symbol(s) of each slot in a period of T_{CSI,j}. The RIS device 20 may reflect the periodic PUCCH, which is transmitted from the terminal j 50 in a period of T_{CSI,j}, through specific symbol(s) of each slot.

A base station 10 may generate a periodic CSI report configuration parameter indicating a PUCCH transmission period of the multiple terminals 40 and 50 in the time domain. The base station 10 may transmit a control signal 700 including a periodic CSI reporting configuration parameter to the RIS device 20. The RIS device 20 may receive the control signal 700 including the periodic CSI reporting configuration parameter from the base station 10.

For example, the periodic CSI report configuration parameters may be time domain parameters related to periodic CSI report transmission. For example, it may include at least one of a slot period for the periodic PUCCH transmission, a slot offset, a start symbol, and a number of symbols. The RIS device 20 may periodically perform an early switching operation in each slot without having to repeatedly receive the control signal 700 whenever the PUCCH is periodically transmitted based on the periodic CSI reporting configuration parameter.

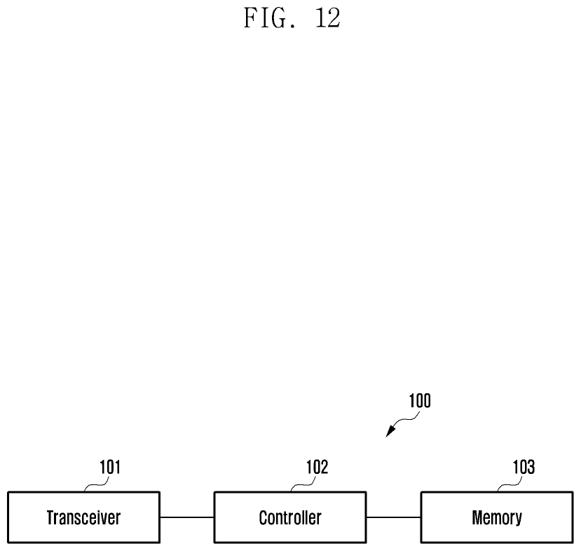

FIG. 12 is a block diagram illustrating a base station 100 in a communication system 1 according to an embodiment of the disclosure.

Referring to FIG. 12, in a network environment, the base station 100 may communicate with an RIS device 20 or multiple terminals 40 and 50 through a network (e.g., a wired or wireless communication network). The base station 100 may be the same as the base station 10 of FIGS. 1 to 11.

According to an embodiment of the disclosure, the base station 100 may include a transceiver 101, a controller 102, and a memory 103. In some embodiments of the disclosure, in the base station 100, at least one of these elements may be omitted or one or more other elements may be added. In some embodiments of the disclosure, some of these elements may be integrated into a single element.

The controller 102 may be configured to, for example, control at least one other element (e.g., a hardware or software element) of the base station 100 connected to the controller 102 and perform various data processing or calculations. According to an embodiment of the disclosure, as at least part of data processing or calculation, the controller 102 may be configured to store commands or data received from other elements (e.g., the transceiver 101) in the memory 103, process commands or data stored in the memory 103, and store the resulting data in the memory 103. The controller 102 may be referred to as a processor.

The memory 103 may store various data used by at least one element of the base station 100. The data may include, for example, software and input data or output data for commands related thereto.

The transceiver 101 may support establishment of a wired communication channel or wireless communication channel between the base station 100 and another electronic device or a server, and communication through the established communication channel. The transceiver 101 may include one or more communication processors configured to operate independently of the controller 102 and support wired or wireless communication. According to an embodiment of the disclosure, the transceiver 101 may communicate with another electronic device or a server through a long-distance communication network, such as a legacy cellular network, a 5G network, a next-generation communication network, the Internet, or a computer network (e.g., local area network (LAN) or wide area network (WAN)). These various types of communication modules may be integrated as one element (e.g., a single chip) or implemented as multiple separate elements (e.g., multiple chips).

The transceiver 101 may support a 5G network, after a 4G network, and next-generation communication technology, e.g., new radio (NR) access technology. The NR access technology may support high-speed transmission of high-capacity data (enhanced mobile broadband (eMBB)), minimization of terminal power and connection of multiple terminals (massive machine type communications (mMTC)), or ultra-reliable and low-latency communications (URLLC). The transceiver 101 may support a high-frequency band (e.g., the mmWave band) to achieve, e.g., a high data transmission rate. The transceiver 101 may support various technologies for securing performance on a high-frequency band, such as, e.g., beamforming, massive multiple-input and multiple-output (MIMO), full dimensional MIMO (FD-MIMO), array antenna, analog beam-forming, or large scale antenna. The transceiver 101 may support various requirements specified in the base station 100, another electronic device, or a network system.

The transceiver 101 may transmit or receive a signal or power to or from the outside (e.g., another electronic device). According to an embodiment of the disclosure, the transceiver 101 may include an antenna including a radiating element composed of a conductive material or a conductive pattern formed on a substrate (e.g., a printed circuit board (PCB)). According to an embodiment of the disclosure, the transceiver 101 may include a plurality of antennas (e.g., array antennas). In such a case, at least one antenna appropriate for a communication scheme used in a network may be selected, for example, by the transceiver 101, from the plurality of antennas. The signal or the power may be transmitted or received between the transceiver 101 and external another electronic device via the selected at least one antenna. According to an embodiment of the disclosure, another component (e.g., a radio frequency integrated circuit (RFIC)) other than the radiating element may be additionally formed as part of the transceiver 101.

According to various embodiments of the disclosure, the transceiver 101 may form a mmWave antenna module. According to an embodiment of the disclosure, the mmWave antenna module may include a PCB, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described elements may be coupled mutually and exchange signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the base station 100 and external another electronic device via a server connected to a network. The external another electronic device may be a device of a same type as, or a different type, from the base station 100. According to an embodiment of the disclosure, all or some of operations to be executed at the base station 100 may be executed at external another electronic device. For example, in case that the base station 100 should perform a function or a service automatically, or in response to a request from a user or another device, the base station 100, instead of or in addition to executing the function or the service, may request the one or more external other electronic devices to perform at least part of the function or the service. The one or more external other electronic devices receiving the request may perform the at least part of the function or the service requested, or an additional function or an additional service related to the request, and transfer a result of the performing to the base station 100. The base station 100 may provide the result, with or without further processing of the result, as at least part of a reply to the request. To this end, a cloud computing, distributed computing, mobile edge computing (MEC), or client-server computing technology may be used, for example. The base station 100 may provide ultra-low-latency services using, e.g., distributed computing or MEC. In another embodiment of the disclosure, external another electronic device may include an Internet-of-things (IoT) device.

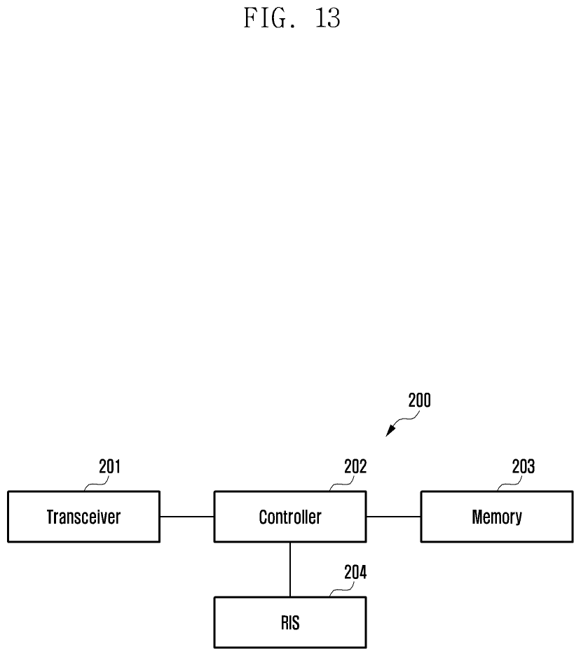

FIG. 13 is a block diagram illustrating an RIS device 200 in a communication system 1 according to an embodiment of the disclosure.

Referring to FIG. 13, in a network environment, the RIS device 200 may communicate with a base station 10 or multiple terminals 40 and 50 through a network (e.g., a wired or wireless communication network). The RIS device 200 may be the same as the RIS device 20 of FIGS. 1 to 11. The RIS device 200 may be referred to as an electronic device.

According to an embodiment of the disclosure, the RIS device 200 may include a transceiver 201, a controller 202, a memory 203, and an RIS 204. In some embodiments of the disclosure, in the RIS device 200, at least one of these elements may be omitted or one or more other elements may be added. In some embodiments of the disclosure, some of these elements may be integrated into a single element. For example, the transceiver 201 and the controller 202 may be referred to as communication nodes. For example, a communication node may include a transceiver 201 and a controller 202.

The controller 202 may, for example, control at least one other element (e.g., hardware or software element) of the RIS device 200 connected to the controller 202, and perform various data processing or calculations. According to an embodiment of the disclosure, as at least part of data processing or calculation, the controller 202 may be configured to store commands or data received from other elements (e.g., the transceiver 201) in the memory 203, and process commands or data stored in the memory 203, and store the resulting data in the memory 203. The controller 202 may be referred to as a processor.

The memory 203 may store various data used by at least one element of the RIS device 200. The data may include, for example, software and input data or output data for commands related thereto.

The transceiver 201 may support establishing a wired communication channel or a wireless communication channel between the RIS device 200 and another electronic device or server, and performing communication through the established communication channel. The transceiver 201 may include one or more communication processors that operate independently of the controller 202 and support wired or wireless communication. According to an embodiment of the disclosure, the transceiver 201 may communicate with another electronic device or a server through a long-distance communication network, such as a legacy cellular network, a 5G network, a next-generation communication network, the Internet, or a computer network (e.g., LAN or WAN). These various types of communication modules may be integrated as one element (e.g., a single chip) or implemented as multiple separate elements (e.g., multiple chips).

The transceiver 201 may support a 5G network, after a 4G network, and next-generation communication technology, e.g., new radio (NR) access technology. The NR access technology may support high-speed transmission of high-capacity data (enhanced mobile broadband (eMBB)), minimization of terminal power and connection of multiple terminals (massive machine type communications (mMTC)), or ultra-reliable and low-latency communications (URLLC). The transceiver 201 may support a high-frequency band (e.g., the mmWave band) to achieve, e.g., a high data transmission rate. The transceiver 201 may support various technologies for securing performance on a high-frequency band, such as, e.g., beamforming, massive multiple-input and multiple-output (MIMO), full dimensional MIMO (FD-MIMO), array antenna, analog beam-forming, or large scale antenna. The transceiver 201 may support various requirements specified in the RIS device 200, another electronic device, or a network system.

The transceiver 201 may transmit or receive a signal or power to or from the outside (e.g., another electronic device). According to an embodiment of the disclosure, the transceiver 201 may include an antenna including a radiating element composed of a conductive material or a conductive pattern formed on a substrate (e.g., a PCB). According to an embodiment of the disclosure, the transceiver 201 may include a plurality of antennas (e.g., array antennas). In such a case, at least one antenna appropriate for a communication scheme used in a network may be selected, for example, by the transceiver 201, from the plurality of antennas. The signal or the power may be transmitted or received between the transceiver 201 and external another electronic device via the selected at least one antenna. According to an embodiment of the disclosure, another component (e.g., a radio frequency integrated circuit (RFIC)) other than the radiating element may be additionally formed as part of the transceiver 201.

The RIS 204 may be the same as or similar to the RIS 21 of FIG. 1. For example, the plurality of RISs 204 may include a plurality of reflection elements (Res). The RIS 204 may be electrically connected to a controller 202. For example, the RIS 204 may be connected to the controller 202 wirelessly or wired. The RIS 204 may receive a control signal from the controller 202. The RIS 204 may control a plurality of Res based on the control signal. The RIS 204 may control respective reflection patterns of a plurality of Res based on the control signal.

According to various embodiments of the disclosure, the transceiver 201 may form a mmWave antenna module. According to an embodiment of the disclosure, the mmWave antenna module may include a PCB, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described elements may be coupled mutually and exchange signals (e.g., commands or data) therebetween via an inter-peripheral communication scheme (e.g., a bus, general purpose input and output (GPIO), serial peripheral interface (SPI), or mobile industry processor interface (MIPI)).

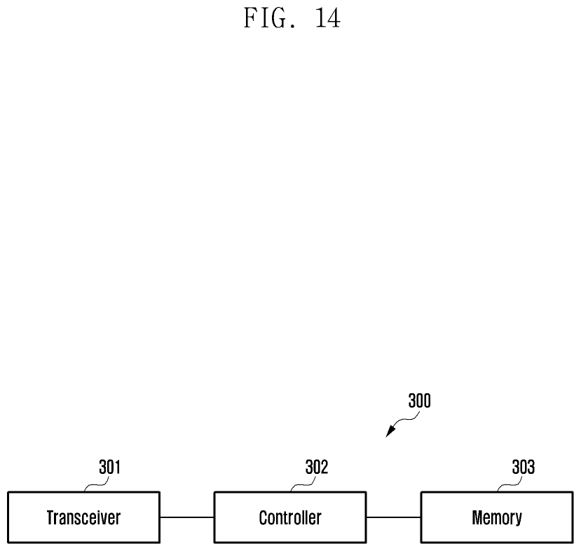

FIG. 14 is a block diagram illustrating a terminal 300 in a communication system 1 according to an embodiment of the disclosure.

Referring to FIG. 14, in a network environment, the terminal 300 may communicate with a base station 100 or an RIS device 200 through a network (e.g., a wired or wireless communication network). The terminal 300 may be the same as the terminal j 40 or the terminal k 50 of FIGS. 1 to 11.

According to an embodiment of the disclosure, the terminal 300 may include a transceiver 301, a controller 302, and a memory 303. In some embodiments of the disclosure, in the terminal 300, at least one of these elements may be omitted or one or more other elements may be added. In some embodiments of the disclosure, some of these elements may be integrated into a single element.

The controller 302 may be configured to, for example, control at least one other element (e.g., a hardware or software element) of the terminal 300 connected to the controller 302 and perform various data processing or calculations. According to an embodiment of the disclosure, as at least part of data processing or calculation, the controller 302 may be configured to store commands or data received from other elements (e.g., the transceiver 301) in the memory 303, process commands or data stored in the memory 303, and store the resulting data in the memory 303. The controller 302 may be referred to as a processor.

The memory 303 may store various data used by at least one element of the terminal 300. The data may include, for example, software and input data or output data for commands related thereto.

The transceiver 301 may support establishment of a wired communication channel or wireless communication channel between the terminal 300 and another electronic device or a server, and communication through the established communication channel. The transceiver 301 may include one or more communication processors configured to operate independently of the controller 302 and support wired or wireless communication. According to an embodiment of the disclosure, the transceiver 301 may communicate with another electronic device or a server through a long-distance communication network, such as a legacy cellular network, a 5G network, a next-generation communication network, the Internet, or a computer network (e.g., LAN or WAN). These various types of communication modules may be integrated as one element (e.g., a single chip) or implemented as multiple separate elements (e.g., multiple chips).

The transceiver 301 may support a 5G network, after a 4G network, and next-generation communication technology, e.g., new radio (NR) access technology. The NR access technology may support high-speed transmission of high-capacity data (enhanced mobile broadband (eMBB)), minimization of terminal power and connection of multiple terminals (massive machine type communications (mMTC)), or ultra-reliable and low-latency communications (URLLC). The transceiver 301 may support a high-frequency band (e.g., the mmWave band) to achieve, e.g., a high data transmission rate. The transceiver 301 may support various technologies for securing performance on a high-frequency band, such as, e.g., beamforming, massive multiple-input and multiple-output (MIMO), full dimensional MIMO (FD-MIMO), array antenna, analog beam-forming, or large scale antenna. The transceiver 301 may support various requirements specified in the terminal 300, another electronic device, or a network system.

The transceiver 301 may transmit or receive a signal or power to or from the outside (e.g., another electronic device). According to an embodiment of the disclosure, the transceiver 301 may include an antenna including a radiating element composed of a conductive material or a conductive pattern formed on a substrate (e.g., a PCB). According to an embodiment of the disclosure, the transceiver 301 may include a plurality of antennas (e.g., array antennas). In such a case, at least one antenna appropriate for a communication scheme used in a network may be selected, for example, by the transceiver 301, from the plurality of antennas. The signal or the power may be transmitted or received between the transceiver 301 and external another electronic device via the selected at least one antenna. According to an embodiment of the disclosure, another component (e.g., a radio frequency integrated circuit (RFIC)) other than the radiating element may be additionally formed as part of the transceiver 301.

According to various embodiments of the disclosure, the transceiver 301 may form a mmWave antenna module. According to an embodiment of the disclosure, the mmWave antenna module may include a PCB, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described elements may be coupled mutually and exchange signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the base station 100 and external another electronic device via a server connected to a network. The external another electronic device may be a device of a same type as, or a different type, from the terminal 300. According to an embodiment of the disclosure, all or some of operations to be executed at the terminal 300 may be executed at external another electronic device. For example, in case that the terminal 300 should perform a function or a service automatically, or in response to a request from a user or another device, the terminal 300, instead of, or in addition to, executing the function or the service, may request the one or more external other electronic devices to perform at least part of the function or the service. The one or more external other electronic devices receiving the request may perform the at least part of the function or the service requested, or an additional function or an additional service related to the request, and transfer a result of the performing to the terminal 300. The terminal 300 may provide the result, with or without further processing of the result, as at least part of a reply to the request. To this end, a cloud computing, distributed computing, mobile edge computing (MEC), or client-server computing technology may be used, for example. The terminal 300 may provide ultra-low-latency services using, e.g., distributed computing or MEC. In another embodiment of the disclosure, external another electronic device may include an Internet-of-things (IoT) device.

Various embodiments as set forth herein may be implemented as software including one or more instructions that are stored in a storage medium (e.g., memories 103, 203, and 303) that is readable by a machine (e.g., the base station 100, the RIS device 200, the terminal 300). For example, a processor (e.g., the transceivers 101, 201, and 301) of the machine (e.g., the base station 100, the RIS device 200, the terminal 300) may invoke at least one of the one or more instructions stored in the storage medium, and execute the same. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term ‘non-transitory’ simply implies that the storage medium is a tangible device, and does not include a signal (e.g., an electromagnetic wave), but this term does not differentiate between where data is semi-permanently stored in the storage medium and where the data is temporarily stored in the storage medium.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a reconfigurable intelligent surface (RIS) including multiple reflection elements; and
a communication node electrically connected to the RIS,
wherein the communication node comprises a transceiver and at least one processor configured to control the multiple reflection elements,
wherein the communication node is configured to:
receive a time estimation value (T_{ES}) associated with propagation delay and a control signal from a base station of a first network, and
based on the time estimation value and the control signal, perform early switching into an uplink reflection pattern at a second time point earlier than a preconfigured first time point, so as to reflect an uplink signal, which is transmitted from a terminal, according to the uplink reflection pattern in response to a timing at which the uplink signal arrives at the RIS.

2. The electronic device of claim 1,
wherein the communication node is configured to, in order to apply the early switching, estimate the time estimate value (T_{ES}) or obtain the time estimation value from the base station of the first network, and
wherein the time estimation value comprises:
a round-trip propagation delay time (2τᵣ) between the base station of the first network and the communication node, and
a timing offset value (τ₀) configured within a bandwidth.

3. The electronic device of claim 2, wherein the communication node is configured to obtain the time estimation value (T_{ES}) through a random access (RA) procedure in an in-band between the base station of the first network and the communication node.

4. The electronic device of claim 2,
wherein the time estimation value (T_{ES}) is estimated by the communication node through a random access procedure in an out-band between the communication node and the base station of the first network,
wherein the communication node is configured to, through the random access procedure with the base station of the first network in the out-band, receive a time estimation value (T_{ES}) in the out-band including the round-trip propagation delay time (2τᵣ) between the base station of the first network and the communication node and a timing offset (τ′₀) configured in the out-band from the base station of the first network,
wherein the communication node is configured to receive all of multiple timing offsets (τ₀, τ′₀) configured in the in- and out-band from the base station of the first network, and
wherein the communication node is configured to estimate the time estimate value (T_{ES}) required for the early switching based on a time estimate value (T_{ES}) in the out-band and the timing offsets (τ₀, τ′₀).

5. The electronic device of claim 2,
wherein in case that the electronic device is connected to the base station of the first network through a communication node of a second network, the round-trip propagation delay time (2τᵣ) between the base station of the first network and the communication node is estimated by the base station of the first network or the communication node based on a round trip time (RTT) estimation method,
wherein in case that the communication node estimates the round-trip propagation delay time, the communication node is configured to:
receive the timing offset (τ₀) configured within a bandwidth required for the early switching, in addition to the propagation delay time, from the base station of the first network, and
estimate the time estimation value required for the early switching based on the round-trip propagation delay time and the timing offset,
wherein in case that the base station of the first network estimates the round-trip propagation delay time, the base station of the first network is configured to estimate the time estimation value required for the early switching based on the round-trip propagation delay time and the timing offset configured within a bandwidth and transmit the estimated time estimation value to the communication node,
wherein in case that the base station of the first network estimates the round-trip propagation delay time, the base station of the first network is configured to transmit the round-trip propagation delay time and the timing offset configured within a bandwidth to the communication node, and
wherein in case that the base station of the first network estimates the round-trip propagation delay time, the communication node is configured to estimate the time estimation value required for the early switching based on the round-trip propagation delay time and the timing offset configured within a bandwidth.

6. The electronic device of claim 1, wherein the control signal comprises reflection pattern information and early switching information.

7. The electronic device of claim 6,
wherein the control signal is transmitted from the base station of the first network to the communication node through a physical layer signal (L1) or higher layer signal (RRC signaling), and
wherein the control signal comprises:
reflection pattern information to be applied to the RIS at each timing, a location of a slot requiring early switching according to a reflection pattern to be applied, and
information indicating the location of a symbol in the slot to which the early switching is applied.

8. The electronic device of claim 7, wherein the location of the slot requiring early switching is indicated to perform early switching in a slot after a slot offset after receiving the control signal, or indicated according to absolute time information by using at least one of a system frame number, a subframe number, and a slot number.

9. The electronic device of claim 6,
wherein, in case that the control signal indicates that the reflection pattern information is applied in units of symbols,
wherein the early switching information indicates a signal reflection direction, in which a signal incident to the RIS is reflected in each symbol, as a downlink direction or an uplink direction according to the reflection pattern,
wherein a location of a symbol in which the signal reflection direction is indicated as the uplink direction corresponds to the first time point, and
wherein the second time point corresponds to a timing preceding as much as the time estimation value (T_{ES}) than a symbol start timing of a slot corresponding to the first time point, or a timing preceding more than the time estimation value than the symbol start timing.

10. The electronic device of claim 6,
wherein the early switching information indicates a location of a symbol in a slot corresponding to the first time point, and
wherein the second time point corresponds to a timing preceding as much as the time estimation value (T_{ES}) than a symbol start timing of a slot corresponding to the first time point or a timing preceding more than the time estimation value than the symbol start timing.

11. The electronic device of claim 10, wherein the early switching information comprises an SRS configuration parameter indicating a periodic sounding reference signal (SRS) transmission period of the terminal.

12. The electronic device of claim 11,
wherein the SRS configuration parameter comprises at least one of a slot period at which the SRS is periodically transmitted, a slot offset, a start symbol, and a number of symbols,
wherein the communication node is configured to determine the first time point, which is periodically repeated based on the SRS configuration parameters, and
wherein the second time point periodically repeated is determined based on the periodically repeated first time point and the time estimation value (T_{ES}).

13. The electronic device of claim 12, wherein the control signal comprises a CSI configuration parameter indicating a periodic channel state information (CSI) transmission period of the terminal.

14. The electronic device of claim 13,
wherein the CSI configuration parameter comprises at least one of a slot period at which the CSI is periodically transmitted, a slot offset, a start symbol, and a number of symbols,
wherein the communication node is configured to determine the periodically repeated first time point based on the CSI configuration parameters, and
wherein the second time point periodically repeated is determined based on the periodically repeated first time point and the time estimation value (T_{ES}).

15. A method for operating an electronic device, the electronic device including a reconfigurable intelligent surface (RIS) including multiple reflection elements, the method comprising:
receiving a time estimation value (T_{ES}) associated with a propagation delay and a control signal from a base station of a first network; and
based on the time estimation value and the control signal, performing early switching into an uplink reflection pattern at a second time point earlier than a preconfigured first time point, so as to reflect a signal, which is transmitted from a terminal, according to the uplink reflection pattern based on a timing at which the signal arrives at the RIS.
